(19) United States
(12) Patent Application Publication
(10) Pub. No.: US 2025/0328978 A1
(43) Pub. Date: Oct. 23, 2025

(54) CARBON-EQUIVALENT OFFSETS FROM CONTRAIL REDUCTION

(71) Applicant: George Mason University, Fairfax, VA (US)

(72) Inventor: Lance SHERRY, Fairfax, VA (US)

(21) Appl. No.: 19/183,655

(22) Filed: Apr. 18, 2025

Related U.S. Application Data
(60) Provisional application No. 63/636,550, filed on Apr. 19, 2024.

(51) Int. Cl. G06Q 50/40

(52) U.S. Cl. CPC G06Q 50/40

(57) ABSTRACT

A system includes at least one processor and at least one memory storing instructions. The instructions, when executed by the at least one processor, cause the system at least to perform: computing radiative forcing of an avoided contrail where the avoided contrail results from an aircraft performing a contrail reduction procedure; determining a computed distance that the aircraft would need to fly to generate carbon emissions that would have a same radiative forcing as the radiative forcing of the avoided contrail; and computing a carbon-equivalent offset for the aircraft performing the contrail reduction procedure as a quantity of carbon that would be generated by the aircraft flying the computed distance.

### CROSS-REFERENCE TO RELATED APPLICATIONS

The present application claims priority to U.S. Provisional Application No. 63/636,550, filed Apr. 19, 2024, which is hereby incorporated by reference herein in its entirety.

### TECHNICAL FIELD

The present disclosure relates to carbon-equivalent offsets, and more particularly, to carbon-equivalent offsets from contrail reduction.

### BACKGROUND

Contrails, also known as aircraft induced clouds (AIC), are ice crystal clouds formed at high altitudes as the result of jet engine emissions. In specific atmospheric conditions, known as ice super saturated (ISS) regions, when there is high humidity and low temperatures, water vapor emitted by the jet engines adheres to soot particles, also emitted by the jet engine, forming ice crystals that grow and form cirrus-like clouds.

These anthropogenic (i.e., human-made) clouds have the property that they reflect back to Earth the outgoing “thermal” radiation emitted by the Earth. This reflection back to earth upsets the Earth's energy balance resulting in an increase in surface and atmospheric temperatures resulting in global warming.

Various estimates attribute 2% of the Earths radiation imbalance to aircraft induced clouds/contrails. The remaining 98% is the result of greenhouse gases (GHGs) such as CO₂ and methane that also mix into the atmosphere and reflect back to Earth outgoing thermal radiation.

Estimates show that 55% of the aviation's anthropogenic global heating is from contrails and 35% is from CO₂ emitted from the jet engines. Whereas CO₂ emissions tend to affect the climate over a long term (e.g., in 20-40 years), contrails have an immediate effect on the Earth's temperature structure.

### SUMMARY

The present disclosure relates to carbon-equivalent offsets from contrail reduction. Aspects of the present disclosure are directed to computing the value of a carbon-equivalent offset for a flight that has performed a contrail reduction procedure.

In accordance with aspects of the present disclosure, a system includes: at least one processor; and at least one memory storing instructions. The instructions, when executed by the at least one processor, cause the system at least to perform: computing radiative forcing of an avoided contrail, where the avoided contrail results from an aircraft performing a contrail reduction procedure; determining a computed distance that the aircraft would need to fly to generate carbon emissions that would have a same radiative forcing as the radiative forcing of the avoided contrail; and computing a carbon-equivalent offset for the aircraft performing the contrail reduction procedure as a quantity of carbon that would be generated by the aircraft flying the computed distance.

In accordance with aspects of the present disclosure, a method includes: computing radiative forcing of an avoided contrail, where the avoided contrail results from an aircraft performing a contrail reduction procedure; determining a computed distance that the aircraft would need to fly to generate carbon emissions that would have a same radiative forcing as the radiative forcing of the avoided contrail; and computing a carbon-equivalent offset for the aircraft performing the contrail reduction procedure as a quantity of carbon that would be generated by the aircraft flying the computed distance.

In accordance with aspects of the present disclosure, a processor-readable medium stores instructions which, when executed by at least one processor of a system, cause the system at least to perform: computing radiative forcing of an avoided contrail, where the avoided contrail results from an aircraft performing a contrail reduction procedure; determining a computed distance that the aircraft would need to fly to generate carbon emissions that would have a same radiative forcing as the radiative forcing of the avoided contrail; and computing a carbon-equivalent offset for the aircraft performing the contrail reduction procedure as a quantity of carbon that would be generated by the aircraft flying the computed distance.

In various embodiments of the system, method, or processor-readable medium, the computing the radiative forcing of the avoided contrail is based on at least one of: a length of the avoided contrail (L_{Con}), a width of the avoided contrail (W_{Con}), an equilibrium surface temperature response, per unit radiative forcing, relative to that of CO2 (E), or degree of climate impact had the avoided contrail not been avoided (M_{Contrail}), where M_{Contrail} is based on a time horizon (H) and one of: absolute global warming potential (AGWP), or absolute global temperature potential (AGTP).

In various embodiments of the system, method, or processor-readable medium, the computing the radiative forcing of the avoided contrail (RF_{Con}) includes computing the RF_{Con} as:

$${RF}_{Con} = {L}_{Con} * {W}_{Con} * E * {M}_{Contrail} ( H ) .$$

In various embodiments of the system, method, or processor-readable medium, the determining the computed distance that the aircraft would need to fly to generate carbon emissions that would have the same radiative forcing as the radiative forcing of the avoided contrail is based on at least one of: the radiative forcing of the avoided contrail (RF_{Con}), a fuel burn per distance (FB), an emissions index (EI), or degree of climate impact from the carbon emissions that would have been generated by the aircraft flying the computed distance (M_{CO2}), where M_{CO2} is based on a time horizon (H) and one of: absolute global warming potential (AGWP), or absolute global temperature potential (AGTP).

In various embodiments of the system, method, or processor-readable medium, the fuel burn per distance is an aircraft-specific value that is specific to the aircraft.

In various embodiments of the system, method, or processor-readable medium, the determining the computed distance (Dist) that the aircraft would need to fly to generate carbon emissions that would have the same radiative forcing as the radiative forcing of the avoided contrail includes computing the Dist as: Dist=RF_{Con}/(FB*EI*M_{CO2}(H)).

In various embodiments of the system, method, or processor-readable medium, the computing the carbon-equivalent offset for the aircraft performing the contrail reduction procedure is based on at least one of: the computed distance (Dist) that the aircraft would need to fly to generate carbon emissions that would have the same radiative forcing as the radiative forcing of the avoided contrail, a fuel burn per distance (FB), or an emissions index (EI).

In various embodiments of the system, method, or processor-readable medium, the fuel burn per distance is an aircraft-specific value that is specific to the aircraft.

In various embodiments of the system, method, or processor-readable medium, the computing the carbon-equivalent offset for the aircraft performing the contrail reduction procedure includes computing the carbon-equivalent offset as: carbon-equivalent offset=Dist*FB*EI.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1A and FIG. 1B are a flow diagram of an example of an operation and environment for generating, listing, and transacting carbon-equivalent offsets from contrail reduction, in accordance with aspects of the present disclosure;

FIG. 2 is a flow diagram of an example of an operation for computing a carbon-equivalent offset and a value of the carbon-equivalent offset, in accordance with aspects of the present disclosure;

FIG. 3 is a diagram of an example of a graph of contrail equivalent CO₂ based on length of an avoided contrail for various absolute global warming potential (AGWP), in accordance with aspects of the present disclosure;

FIG. 4 is a diagram of an example of a graph of value of carbon-equivalent offset based on the carbon-equivalent offsets shown in FIG. 3, in accordance with aspects of the present disclosure;

FIG. 5 is a diagram of an example of a graph of contrail equivalent CO₂ based on length of an avoided contrail for various absolute global temperature potential (AGTP), in accordance with aspects of the present disclosure;

FIG. 6 is a diagram of an example of a graph of value of carbon-equivalent offset based on the carbon-equivalent offsets shown in FIG. 5, in accordance with aspects of the present disclosure;

FIG. 7 is a flow diagram of example operations of a system that computes a carbon-equivalent offset for the aircraft performing the contrail reduction procedure, in accordance with aspects of the present disclosure; and

FIG. 8 is a block diagram of example components of a system that provides at least a portion of the platform and services of FIGS. 1A, 1B, and 2, in accordance with aspects of the present disclosure.

### DETAILED DESCRIPTION

The present disclosure relates to carbon-equivalent offsets from contrail reduction. Aspects of the present disclosure are directed to computing a carbon-equivalent offset for a flight that has performed a contrail reduction procedure. The terms “contrail”, “aircraft induced cloud”, and “AIC” may be used interchangeably.

Aspects of the present disclosure relate to radiative forcing (RF). In aspects, RF is the change in the top-of-atmosphere energy budget due to constituents such as contrails, CO₂, or other greenhouse gases. The Earth's total net RF is the difference between the incoming solar radiation and outgoing thermal radiation at the top of Earth's atmosphere. The net RF defines the Earth's energy balance for maintaining Earth's climatic temperature in a range appropriate for living organisms.

When the energy emitted by the sun, in the form of solar radiation, reaches the Earth, some of it is reflected back into space by naturally formed clouds, atmospheric particles, and by the Earth's surface. The remaining solar radiation is absorbed by the Earth's surface, warming the planet. The Earth, having absorbed solar energy, re-emits it in the form of infrared (IR) radiation. This outgoing IR radiation released into space is essential for maintaining the Earth's energy balance.

Naturally occurring greenhouse gases in the atmosphere, such as carbon dioxide (CO₂), methane (CH₄), and water vapor, trap some of the outgoing infrared radiation. This trapping effect warms the atmosphere and the Earth's surface. Human activities, however, such as burning fossil fuels and deforestation, increase the concentration of greenhouse gases in the atmosphere. This enhanced greenhouse effect leads to additional trapping of infrared radiation, causing an imbalance in the energy budget and contributing to an increase in the Earth's climatic temperature.

Persistent contrails also have a “greenhouse effect.” In various scenarios, contrails can block 33% of the outgoing thermal radiation and create an anthropogenic climate effect. During daylight hours, persistent contrails can also have a small albedo effect, which in various scenarios may reflect back to space approximately 23% of the incoming solar radiation that interact with the contrail.

The overall greenhouse effect is measured by effective radiative forcing (ERF) and surface temperature change (ATS). ERF is a modification to RF that includes rapid adjustments, such as atmospheric changes (e.g., cloudiness, humidity) that occur in absence of any surface temperature change. Surface temperature change (ATS) is the impact of ERF on surface temperature.

In various scenarios, specific ERF for CO₂ is estimated at 1.77E-15 W/m² per kg CO₂, and the specific ERF forcing for contrails is estimated at 1.86E-8 W/m² per km² of contrail surface.

Various metrics can be used to assess the impact of forcing events on radiative forcing and temperature over several decades. Two widely used metrics are global warming potential (GWP) and global temperature potential (GTP).

GWP is a metric used to compare the radiative forcing effect of various forcing agents (e.g. greenhouse gases, contrails) over a specified time horizon, usually 20, 100, or 500 years. It quantifies how much heat (Watts/m² per year) a particular forcing agent traps in the atmosphere compared to carbon dioxide (CO₂). In this way, GWP is expressed as a factor relative to CO₂, which has a GWP of 1. For example, if a forcing agent has a GWP of 25, it means that over a specific time period, it has 25 times the warming potential of CO₂.

GTP goes one step further down the cause-effect chain from GWP to define the change in global mean surface temperature at a chosen point in time in response to a forcing agent pulse. GTP measures the temperature change resulting from a one-time pulse, considering the response of the climate system over time, usually 20, 50, 100 years. GTP is also defined relative to the impact of CO₂.

In general, GTP is considered to provide a more nuanced understanding of the short- and long-term effects of different forcing events on global temperatures. Whereas GWP is integrated in time, GTP is an end-point metric that is based on temperature change for a selected year.

Absolute GWP (AGWP) and absolute GTP (AGTP) is radiative forcing and temperature change per unit emission. In various scenarios, specific forcing for AGTP and AGWP for contrails and CO₂ may have the values shown in Table 1 below.

TABLE 1

| | Specific | | | | | | |
|---|---|---|---|---|---|---|---|
| Forcing | Forcing | AGWP (W/m² yr kg(CO₂)) | | | AGTP (Kelvin/km²) | | |
| Agent | (W/m² X) | 20 Yr | 50 Yr | 100 Yr | 20 Yr | 50 Yr | 100 Yr |
| Contrail | 1.96E−08 | 1.10E−11 | 1.10E−11 | 1.10E−11 | 8.90E−14 | 1.30E−14 | 9.20E−15 |
| CO₂ | 1.77E−15 | 2.50E−11 | 5.40E−14 | 9.30E−14 | 6.60E−14 | 5.60E−16 | 4.90E−16 |

As shown in Table 1, using the GTP and GWP metrics, the impact of contrails is magnitudes greater than the impact of CO₂ emissions in 50 and 100-year periods (e.g. E-11 vs E-14). This may happen because even though CO₂ is present in the atmosphere for decades, and contrail dissipates in less than 10 hours, the increase in temperature based on contrails integrates over time, yielding a larger impact in the future.

There have been proposals to avoid the generation of contrails. One proposal involves raising aircraft cruise flight levels by 1,000-2,000 feet to avoid flying through ice super saturated (ISS) regions. It is estimated that such higher aircraft cruise flight levels will effect, on average, only 15% of the flights per day in the National Airspace System (NAS) and will require additional fuel burn of just less than 1% per flight in the NAS. Estimates show that, in most cases, flights at the higher aircraft cruising level would impose no additional fuel burn or enroute time because the additional cost (e.g., fuel burn) of ascending to a higher aircraft cruising flight level is offset by reduced drag at the higher altitude, which results in lower fuel burn. And since only a small percentage of flights (on average 15% per day) generate contrails, adjusting aircraft cruising levels for the small percentage of flights would not create additional air traffic control congestion or workload.

To incentivize contrail reduction, an exchange platform for listing and transacting carbon-equivalent offsets from contrail reduction was described in U.S. Patent Application Publication No. 2024/0028053, which is hereby incorporated by reference herein in its entirety. A carbon-equivalent offset from contrail reduction may represent the equivalent amount of CO₂ reduction that would result in the same climate benefit (e.g., radiation savings) provided by the contrail reduction. In various embodiments, a carbon-equivalent offset from contrail reduction may represent other carbon reduction quantities that would result in the same climate benefit provided by the contrail reduction. Persons skilled in the art will recognize such other carbon reduction quantities. The description herein may refer to CO₂-equivalent offset as an example of carbon-equivalent offset, and the CO₂-equivalent offset may be referred to by the term “eCO2 offset.” It is intended that any description referring to “eCO2 offset” shall be treated as though the same description referred to carbon-equivalent offset in general.

An exchange platform allows airlines to earn money by taking intentional actions to reduce generation of contrails. Buyers of the carbon-equivalent offsets could be other airlines or other entities seeking to offset greenhouse gas emissions. The exchange platform may also provide a secondary market for parties that have purchased the carbon-equivalent offsets to sell them, thereby providing liquidity for the carbon-equivalent offsets and further incentivizing airlines to generate them.

It is important to establish the legitimacy of the carbon-equivalent offsets generated by contrail reduction actions. This legitimacy may be established in the manner described in U.S. Patent Application Publication No. 2024/0028053, by using a contrail formation model, a contrail persistence model, and a contrail net radiative forcing model, together with flight track data, predicted and actual atmospheric data, and/or satellite images and/or terrestrial images. For carbon-equivalent offsets that are deemed to be legitimate, the carbon-equivalent offset may be certified and designated as unique property for exchange and may be exchanged between sellers and buyers of carbon-equivalent offsets.

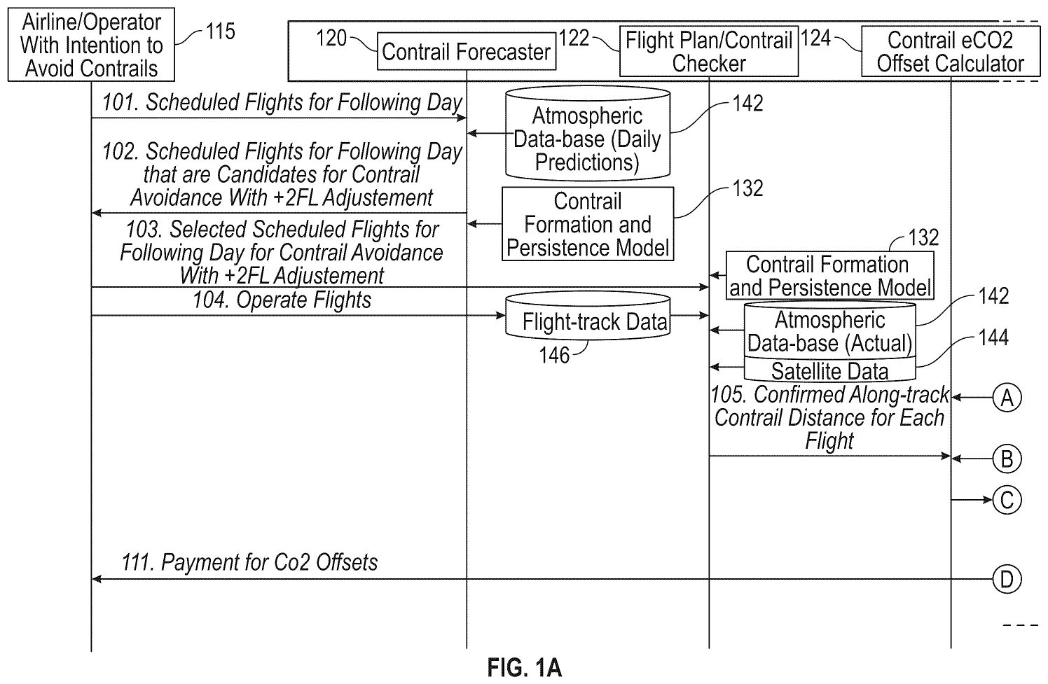

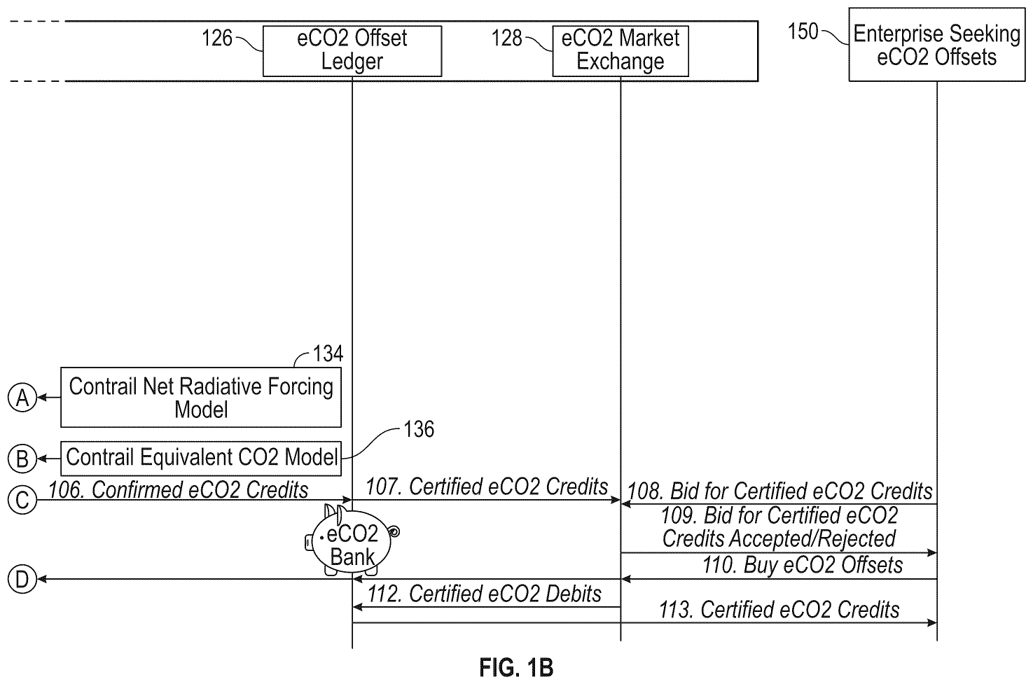

FIG. 1A and FIG. 1B show an operation and an environment for generating, listing, and transacting carbon-equivalent offsets from contrail reduction. The environment includes one or more airliners 115 that interact with the platform (including, e.g., components 120-146) to generate carbon-equivalent offsets from contrail reductions and includes other entities or airliners 150 that interact with the platform to purchase the carbon-equivalent offsets.

The airliner 115 may be an airline company or flight operator company. Airlines and other flight operators are free to plan flights to transit the airspace. Each flight is required to “file” a flight plan with the Air Navigation Service Provider (ANSP). The flight plan takes into account aircraft performance with the intended payload and fuel (e.g., rate of climb, max cruising flight level), atmospheric conditions (e.g., jet stream and other wind, temperature, weather disturbances such as thunderstorms, etc.), and expected traffic loads. With regard to airspace operations (not airports), the ANSP will generally accept the proposed flight route as-is. In some circumstances, when the airspace is closed or when the airspace capacity is less than the demand, the route can be amended. Flight plans may be filed from three (3) hours before departure until the time of departure. Once the flight is airborne, the flight plan can only be amended within the performance constraints of the aircraft (e.g., maximum cruise flight level) and fuel endurance.

The platform provides various services to the airliner 115, which may be an airliner with intention to avoid contrails and use or sell CO₂ offsets. The platform may be implemented as a standalone system, a distributed system, a cloud-based system, or some combination of these, among other implementations. Although the platform is illustrated in FIG. 1A and FIG. 1B with many components, in various embodiments, certain components may be third party components that are outside the platform and that may be accessed by the platform via third party systems, such as via application programming interfaces (APIs) and/or data subscription feeds, among other possibilities. For example, in various embodiments, one or more of the databases 142, 144, 146 and/or one or more of the services 120-128 may be provided by third parties. Such variations and contemplated to be within the scope of the present disclosure.

The platform provides various services, including an aircraft induced cloud (AIC) forecaster 120, a flight plan and contrail checker 122, an AIC carbon-equivalent offset calculator 124, a carbon-equivalent offset ledger/bank 126, and a carbon-equivalent offset exchange service 128. Each of the services may be implemented by processor-readable instructions which provide the services when the instructions are executed by one or more processors. Altogether, the services 120-128 collaborate to designate certain scheduled flights for a contrail reduction procedure, check whether the designated flights executed the contrail reduction procedure and achieved contrail reduction, compute carbon-equivalent offsets for the designated flights that executed the contrail reduction procedure, and list the carbon-equivalent offsets in an exchange and execute transactions for the listed carbon-equivalent offsets. Interactions and operations of these services and parties are illustrated by interactions and operations 101-113. The models 132-136 and the databases 142-146 used by the services 120-128 are illustrated near the interactions and operations where they are used, and aspects of their implementations are described in U.S. Patent Application Publication No. 2024/0028053.

At interaction 101, the airliner 115 communicates, to the contrail forecaster 120, a list of scheduled flights (e.g., for the same day, following day, or another day/time), and the contrail forecaster 120 receives the list of scheduled flights.

After interaction 101, the contrail forecaster 120 accesses the atmospheric database 142 and applies the contrail formation model and contrail persistence model 132 to determine scheduled flights which are candidates for a contrail reduction procedure. The contrail formation model and contrail persistence model 132 may use what is known as the Schmidt-Appleman criterion to identify contrail formation in certain atmospheric conditions that give rise to ISS regions. The atmospheric conditions may be identified using atmospheric data from the atmospheric database 142. Scheduled flights for which a cruising flight level adjustment is predicted to avoid one or more ice super saturated (ISS) regions become candidates for contrail reduction.

At interaction 102, the contrail forecaster 120 communicates, to the airliner 115, the scheduled flights which are candidates for a contrail reduction procedure, along with the corresponding contrail reduction procedure (e.g., increasing or decreasing cruising flight level by 2,000 feet or 4,000 feet, among other adjustments), and the airliner 115 receives such information. In various embodiments, the contrail forecaster 120 or the contrail carbon-equivalent offset calculator 124 may communicate, to the airliner 115, an estimated monetary value of predicted carbon-equivalent offsets from contrail reduction.

After interaction 102, the airliner 115 decides whether to designate certain scheduled flights for contrail reduction procedure. For example, the airliner 115 may decide to designate flights that have a sufficiently large estimated monetary value of predicted carbon-equivalent offsets from the contrail reduction procedure (e.g., estimated monetary value above a threshold value). In various embodiments, the airliner 115 may use other criteria to select and designate scheduled flights for contrail reduction procedure.

At interaction 103, the airliner 115 communicates, to the flight plan and contrail checker 122, the list of scheduled flights which are designated for contrail reduction procedure, and the flight plan and contrail checker 122 receives the list of designated flights.

At interaction 104, the airliner 115 operates the flights, and flight tracking data is collected and stored in the flight track database 146. As mentioned above, in various embodiments, the flight track database 146 may be provided by third party services, such as ADS-B Exchange, among other services. In various embodiments, the flight track database 146 may be proprietary to the platform but may be populated by data feeds from third party databases.

After interaction 104, the flight plan and contrail checker 122 operates to determine whether a flight that was designated for contrail reduction procedure (e.g., cruising flight level adjustment or otherwise) has executed the contrail reduction procedure and achieved contrail reduction. The flight plan and contrail checker 122 may determine whether a flight executed a contrail reduction procedure by using the flight track data from the flight track database 146. The flight plan and contrail checker 122 also operates to confirm contrail reduction using one or both of actual atmospheric data 142 relating to a flight path and/or satellite images and/or terrestrial images 144 of the flight path.

In case the flight plan and contrail checker 122 determines that a flight avoided at least a portion of ISS regions and/or satellite images and/or terrestrial images show a lack of contrails along at least a portion of a flight path, the flight plan and contrail checker 122 and/or the contrail forecaster 120 may determine an amount or percentage of contrail that was reduced (e.g., partially or wholly reduced).

At interaction 105, the flight plan and contrail checker 122 and/or the contrail forecaster 120 may provide or communicate, to the AIC carbon-equivalent offset calculator 124, contrail reduction information on a difference between the contrail that would have been formed by the original, unadjusted flight path and the contrail (or absence thereof) that resulted from the adjusted flight path, and the AIC carbon-equivalent offset calculator 124 receives such information.

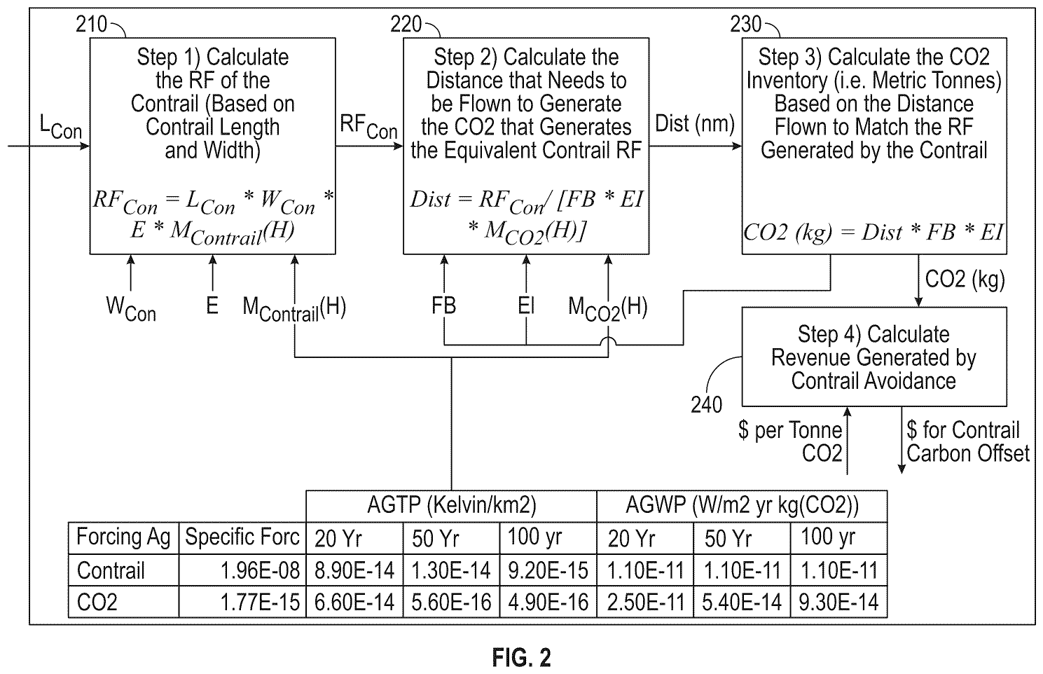

After interaction 105, the AIC carbon-equivalent offset calculator 124 determines the carbon-equivalent offset corresponding to a contrail reduction procedure for a flight. The AIC carbon-equivalent offset calculator 124 may apply an estimated net radiative forcing model 134 and an equivalent CO₂ model 136 to determine the carbon-equivalent offset for the flight. The estimated net radiative forcing model 134 operates to determine the amount of radiation that reflects into space instead of being trapped by a contrail. Generally, the term “radiative forcing” refers to what happens when the amount of energy that enters the Earth's atmosphere is different from the amount of energy that leaves the Earth's atmosphere. The estimated net radiative forcing model 134 is applied to the contrail reduction information to determine the amount of radiation that reflects into space, instead of being trapped, as a result of the modified flight plan, and the equivalent CO₂ model 136 determines the carbon-equivalent offset for that amount of radiation. The equivalent CO₂ model 136 may compute quantities known as an absolute global warming potential (AGWP) or absolute global temperature potential (AGTP). As mentioned above, the carbon-equivalent offset from contrail reduction may represent the equivalent amount of CO₂ reduction that would result in the same climate benefit (e.g., radiation savings) provided by the contrail reduction. Further aspects of the AIC carbon-equivalent offset calculator 124 will be described below in connection with FIGS. 2-8.

At interaction 106, the AIC carbon-equivalent offset calculator 124 provides or communicates the carbon-equivalent offsets to the carbon offset bank/ledger 126, which keeps accounts of carbon-equivalent offsets owned by the airliner 115 or by other parties, and the carbon offset bank/ledger 126 receives the carbon-equivalent offsets.

At interaction 107, the carbon offset bank/ledger 126 provides or communicates the carbon-equivalent offsets to the carbon offset exchange service 128 to be listed and transacted, and the carbon offset exchange service 128 receives the carbon-equivalent offsets.

At interaction 108, the entities 150 seeking to offset carbon emissions communicate bids for a carbon-equivalent offset to the carbon offset exchange service 128.

After interaction 108, the carbon offset exchange service 128 may evaluate the bid in the same manner that a securities exchange evaluates bids, such as evaluate whether there is sufficient overlap between bid and ask prices. A bid may be rejected, for example, if it does not overlap with any ask prices or if it is not a winning bid. In various embodiments, the carbon offset exchange service 128 may implement other criteria for accepting or rejecting bids, such as implementing a purchase limit for individual accounts, e.g., per day limit or per week limit or a limit for another time period, for example. Such and other criteria for accepting or rejecting bids are contemplated to be within the scope of the present disclosure.

At interaction 109, the carbon offset exchange service 128 informs the entity 150 whether the bid was accepted or rejected. FIG. 1A and FIG. 1B proceed on the assumption that the bid was accepted. Assuming the bid is accepted, then at interaction 110, the entity 150 purchases the carbon-equivalent offset and communicates payment of the purchase amount to the carbon offset exchange service 128, and the carbon offset exchange service 128 receives the payment.

At interaction 111, the carbon offset exchange service 128 communicates the purchase amount to the airliner 115 which generated the carbon-equivalent offset, and the airliner 115 receives the purchase amount.

At interaction 112, the carbon offset exchange service 128 communicates the purchase to the carbon offset ledger/bank 126, which updates its records to reflect the purchase and change of ownership by debiting the account of the airliner 115 and crediting the account of the purchasing entity 150. At interaction 113, the carbon offset ledger/bank 126 communicates the crediting of the purchasing entity's account to the entity 150.

Accordingly, the interactions of FIG. 1A and FIG. 1B provide a system for confirming that contrail reduction occurred, thereby providing legitimacy for carbon-equivalent offsets from contrail reduction. The interactions provide an exchange service for listing and transaction carbon-equivalent offsets from contrail reduction, which provides a liquid market for such carbon-equivalent offsets and incentivizes airlines to take contrail reduction procedures.

FIG. 1A and FIG. 1B and their corresponding description are merely illustrative, and variations are contemplated to be within the scope of the present disclosure. In various embodiments, the interactions may include other interactions not shown in FIG. 1A or FIG. 1B. In various embodiments, the interactions may not include all of the interactions shown in FIG. 1A and/or FIG. 1B. In various embodiments, the interactions may have a different order than those shown in FIG. 1A and/or FIG. 1B. Such and other variations are contemplated to be within the scope of the present disclosure.

An operation and environment for generating, listing, and transacting carbon-equivalent offsets from contrail reduction were described above. The sale of carbon-equivalent offsets from contrail reduction requires the conversion of contrail radiative forcing that would have occurred if the flight had operated as usual (i.e., had not performed a contrail reduction procedure), to an equivalent CO₂ radiative forcing. The following will describe the computation of carbon-equivalent offsets in more detail.

FIG. 2 is a flow diagram of an example of an operation for computing a carbon-equivalent offset and a value of the carbon-equivalent offset from a contrail reduction procedure. As mentioned above, the carbon-equivalent offset from a contrail reduction procedure determines the contrail radiative forcing that would have occurred had the flight operated as usual and had not performed a contrail reduction procedure, converted to an equivalent CO₂ radiative forcing. The description below uses certain units of measure. Any units of measure are merely examples, and aspects of the present disclosure are not limited to any particular units of measure. Other units of measure may be used and are contemplated to be within the scope of the present disclosure. To the extent different units of measure may be used in different portions of the present disclosure, values for one unit of measure may be converted to values for a different unit of measure without departing from the scope of the present disclosure.

In aspects, the operation determines a computed distance that an aircraft would need to fly to generate CO₂ emissions that would have the same radiative forcing as the radiative forcing generated by an avoided contrail which would have occurred without the contrail reduction procedure. Generally, the computed distance for CO₂ emissions is much longer than the length of the avoided contrail. The operation calculates the CO₂ quantity (in tons) generated by the difference in distance, i.e., difference between the compute distance and the length of the avoided contrail.

At block 210, the operation involves calculating the RF of the avoided contrail, e.g., based on the avoided contrail's length and width.

In various embodiments, the radiative forcing for contrails (RF_{Con}) can be estimated by equation (1) shown in block 210 and below. RF_{Con} is determined by the area covered by the contrail, defined by the length of the contrail (L_{Con}) times the width of the contrail (W_{Con}), an efficiency factor (E), and the GTP and/or GWP impact over time horizons of 20, 50, and 100 years.

$${RF}_{Con} = {L}_{Con} * {W}_{Con} * E * {M}_{Contrail} ( H ) \qquad ( 1 )$$

where:
   RF_{Con} is the radiate forcing from Contrails (W/m² per kg CO₂ or Kelvin per kg CO₂),
   L_{Con} is the length of the Contrail (km),
   W_{Con} is the width of the Contrail (km),
   E is the equilibrium surface temperature response, per unit radiative forcing, relative to that of the equivalent CO₂ to the radiative forcing from Contrails (W/m² per kg CO₂ or Kelvin per kg CO₂),
   M_{Contrail} (H)=climate impact with a time horizon (H) of 20, 50, or 100 years (Kelvin per km², or W/m² per year per kg CO₂), e.g., as shown in Table 1 above.

L_{Con} may be determined as the distance traveled by the aircraft through an ISS region. In this way, L_{Con} can be determined by the size of the ISS region and the path the aircraft takes through the ISS region.

W_{Con} may be determined by the lifetime of the contrail and the magnitude of the vertical wind shear, which acts to increase the effective horizontal cross-section of the contrail. The lifetime of long-lived contrails varies, as long-lived contrails become more difficult to track once they evolve into contrail-cirrus in the presence of wind advection. Contrail cirrus has been observed up to 24 hours, and modeling of individual contrails suggests a modal lifetime of 1 hour and a typical duration of less than 6 hours. The range of observed and modeled linear contrail widths is 1-10 km, generally with a peak at smaller values. In various embodiments, the value of W_{Con} can be a configurable value that can be set by a user or can be a default value. In various embodiments, the value of W_{Con} may be 0.5 km, which may be a default value or may be a value set by a user. Other values of W_{Con} are contemplated to be within the scope of the present disclosure.

The factor E may have a value as described in Irvine et. al., “A simple framework for assessing the trade-off between the climate impact of aviation carbon dioxide emissions and contrails for a single flight,” Environmental Research Letters, Volume 9, Number 6, 064021, IOP Publishing Ltd, pages 1-6 (2014). In various embodiments, this parameter may have low impact on the result. Thus, in various embodiments, the value of E may be set to 1. In various embodiments, values of E may be provided by Intergovernmental Panel on Climate Change (IPCC), which uses and refines E values.

In various embodiments, the factor E may reflect certain variables. Contrail radiative forcing varies with the time of day, the natural cloud cover, contrail thickness (which may depend on aircraft type), and/or the underlying surface. In various embodiments, contrail specific radiative forcing may be estimated based on a scenario where a global homogeneous contrail cover of 1% with an optical depth of 0.3 has an annual mean all-sky net radiative forcing of about 0.1 W/m². Such variables may be reflected in the factor E.

At block 220, the operation involves determining the computed distance that an aircraft would need to fly to generate CO₂ emissions that would have the same radiative forcing as that of the avoided contrail.

In various embodiments, the computed distance can be estimated by equation (2b) shown in block 220 and below. For a given distance, the fuel burn per distance (FB) generates a quantity of CO₂ that is determined the aircraft's Emissions Index (EI). This quantity of CO₂ generates a radiative forcing based on the measure of GWP or GTP and the time horizon (e.g. 20, 50, 100 years). This relationship is shown in equation (2a).

$${RF}_{CO 2} = Dist * FB * EI * {M}_{CO 2} ( H ) \qquad ( 2 a )$$

where:
   RF_{CO2} is the radiate forcing from CO₂ (W/m² per kg CO₂ or Kelvin per kg CO₂),
   FB is the Fuel Burn per distance (kg fuel per km),
   EI is the Emissions Index for CO₂ (e.g., 3.16 kg CO₂/kg fuel)
   M_{CO2}(H) is the climate impact with a time horizon (H) of 20, 50 and 100 years (Kelvin per kg CO₂, or W/m² per year per kg CO₂) e.g., as shown in Table 1 above.

By setting RF_{CO2}=RF_{Con}, which was computed in block 210, the computed distance (Dist) can be computed by:

$$Dist = {RF}_{Con} / ( FB * EI * {M}_{CO 2} ( H ) ) \qquad ( 2 b )$$

Various parameter values in equations (2a) and (2b) may be aircraft-specific, such as fuel burn (FB) and emissions index (EI). Because the parameters may be aircraft-specific, the operations of block 220 may provide computations that are more accurate than generalized approaches that are not aircraft-specific.

FB varies depending on the aircraft type. Representative values of FB for different classes of aircraft (referred to as small, medium, large and very large jets) may be derived from the base of aircraft data (BADA) model, assuming 70% maximum takeoff gross weight (TOGW) and assuming cruise altitudes. Values of FB may range from about 3 kg/km to 11 kg/km.

At block 230, the operation involves computing the CO₂ amount (e.g., metric tons) that would be generated by the aircraft flying the computed distance (Dist), provided by block 220.

In various embodiments, the CO₂ amount can be computed by equation (3) shown in block 230 and below.

$${CO}_{2} ( kg ) = Dist * FB * EI \qquad ( 3 )$$

where:
   CO₂ is the quantity of CO₂ (kg), which is generally reported as metric tons (=1000 kg),
   Dist is the computed distance provided by equation (2b),
   FB is the fuel burn used in equation (2b), and
   EI is the Emissions Index used in equation (2b).

As with equation (2b), the parameters of equation (3) may also be aircraft-specific. Thus, the computation of equation (3) may also be more accurate than generalized models that are not aircraft-specific.

At block 240, the operation involves calculating a monetary value of the CO₂ amount, computed in block 230, having been avoided, i.e., calculating a monetary value of the carbon-equivalent offset corresponding to the contrail reduction procedure.

In various embodiments, the monetary value can be computed by multiplying the CO₂ amount (tons) by the market rate for carbon offsets, as shown in equation (4) below.

$$Monetary value = {CO}_{2} ( tons ) * Rate for Carbon Offset \qquad ( 4 )$$

In various embodiments, the Rate for Carbon Offset may be a real time market rate that is determined by the market in the platform described in connection with FIG. 1. In various embodiments, Rate for Carbon Offset may be a market rate at the close of the prior business day in the platform described in connection with FIG. 1. Such and other embodiments are contemplated to be within the scope of the present disclosure.

By the operations of FIG. 2, an amount of carbon-equivalent offset for a contrail reduction procedure may be computed by block 230, and the monetary value of the carbon-equivalent offset may be computed by block 240.

FIG. 2 and the description above are merely examples, and variations are contemplated to be within the scope of the present disclosure. Equations (1)-(4) are merely examples, and other equations or techniques for computing the quantities described in FIG. 2 are contemplated to be within the scope of the present disclosure, including other equations or techniques which are aircraft-specific.

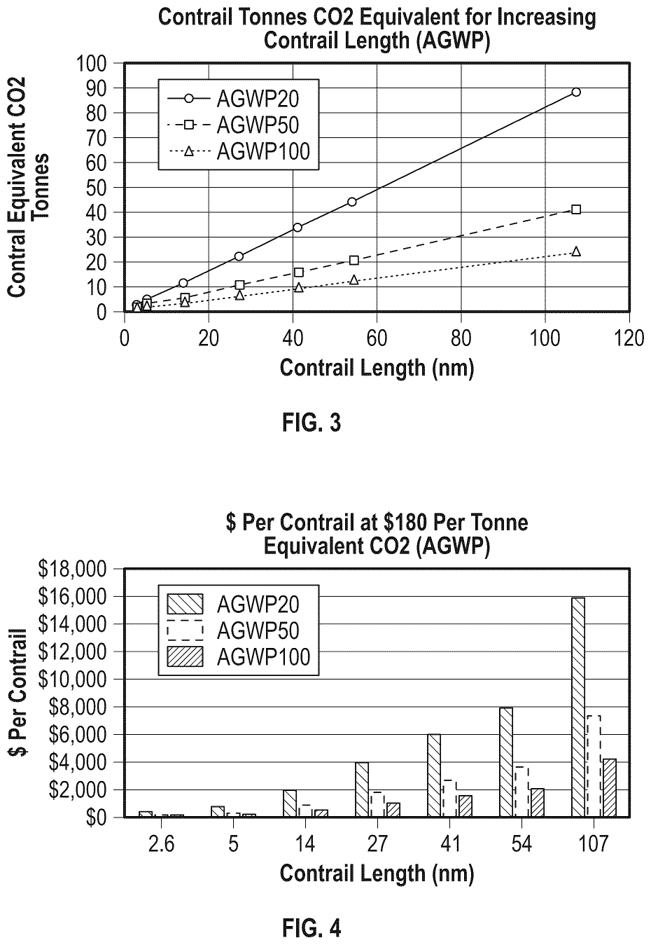

FIG. 3 is an example of a graph of contrail equivalent CO₂ based on length of avoided contrail (e.g., in nautical miles, nm) for various absolute global warming potential (AGWP) and various parameter values (e.g., parameters values described with respect to FIG. 2). Using AGWP values, e.g., from Table 1, equations (1)-(3), and various parameter values used in equations (1)-(3), an example of the CO₂ amounts corresponding to the length of avoided contrail are shown in FIG. 3.

The quantity of CO₂ (tons), computed for individual flights with avoided contrails from 2.6 nm (5 km) to 107 nm (200 km), is linear and ranges from 0.83 tons per nm (AGWP-20), 0.38 tons per nm (AGWP-50), and 0.22 tons per nm (AGWP-100). The quantity of CO₂ (tons) for each length of avoided contrail (from 2.6 nm to 107 nm) shows that the quantity for AGWP-20 years exceeds the quantities for AGWP-50 years and AGWP-100 years.

FIG. 3 and the description above are merely examples, and variations are contemplated to be within the scope of the present disclosure.

FIG. 4 is an example of a graph of monetary value of carbon-equivalent offset based on the carbon-equivalent offsets shown in FIG. 3. The monetary values can be computed using equation (4), a rate for carbon offset, and the carbon-equivalent offset quantities from FIG. 3.

An estimate for the potential monetary value of carbon-equivalent offset per flight using the AGWP metric ranges from $106 to $15,840, depending on the length of the avoided contrail and the time horizon used for assessing climate impact. The average monetary value per nautical mile (nm) of avoided contrails is $149 per nm, $69 per nm, and $4 per nm for AGWP-20, AGWP-50, and AGWP-100, respectively.

FIG. 4 and the description above are merely examples, and variations are contemplated to be within the scope of the present disclosure.

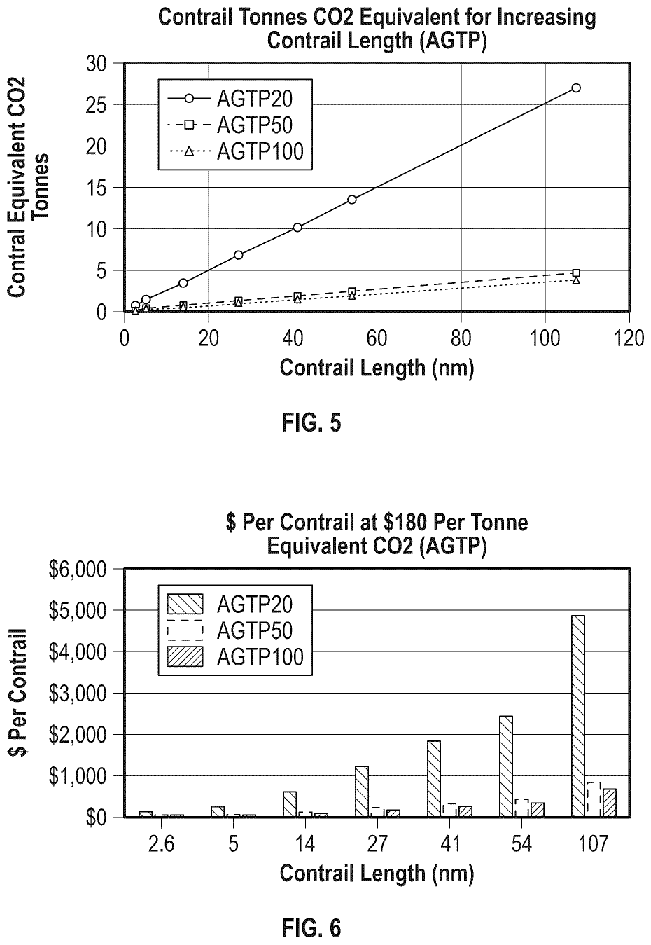

FIG. 5 is a diagram of an example of a graph of contrail equivalent CO₂ based on length of avoided contrail for various absolute global temperature potential (AGTP) and various parameter values (e.g., parameters values described with respect to FIG. 2). Using AGTP values, e.g., from Table 1, equations (1)-(3), and various parameter values used in equations (1)-(3), an example of the CO₂ amounts corresponding to the length of avoided contrail are shown in FIG. 5.

The quantity of CO₂ (tons), computed for individual flights with avoided contrails from 2.6 nm (5 km) to 107 nm (200 km), is linear and ranges from 0.14 tons per nm (AGTP-20), 0.04 tons per nm (AGTP-50), and 0.04 tons per nm (AGTP-100). The quantity of CO₂ (tons) for each length of avoided contrail (from 2.6 nm to 107 nm) shows that the quantity for AGWP-20 years exceeds the quantities for AGWP-50 years and AGWP-100 years.

FIG. 5 and the description above are merely examples, and variations are contemplated to be within the scope of the present disclosure.

FIG. 6 is an example of a graph of value of carbon-equivalent offset based on the carbon-equivalent offsets shown in FIG. 5. The monetary values can be computed using equation (4), a rate for carbon offset, and the carbon-equivalent offset quantities from FIG. 5.

An estimate for the potential monetary value of carbon-equivalent offset per flight using the AGTP metric ranges from $17 to $14,860, depending on the length of the avoided contrail and the time horizon used for assessing climate impact. The average monetary value per nautical mile of contrails is $46 per n.m., $8 per n.m., $6 per n.m. for AGTP-20, AGTP-50, and AGTP-100 respectively.

FIG. 6 and the description above are merely examples, and variations are contemplated to be within the scope of the present disclosure.

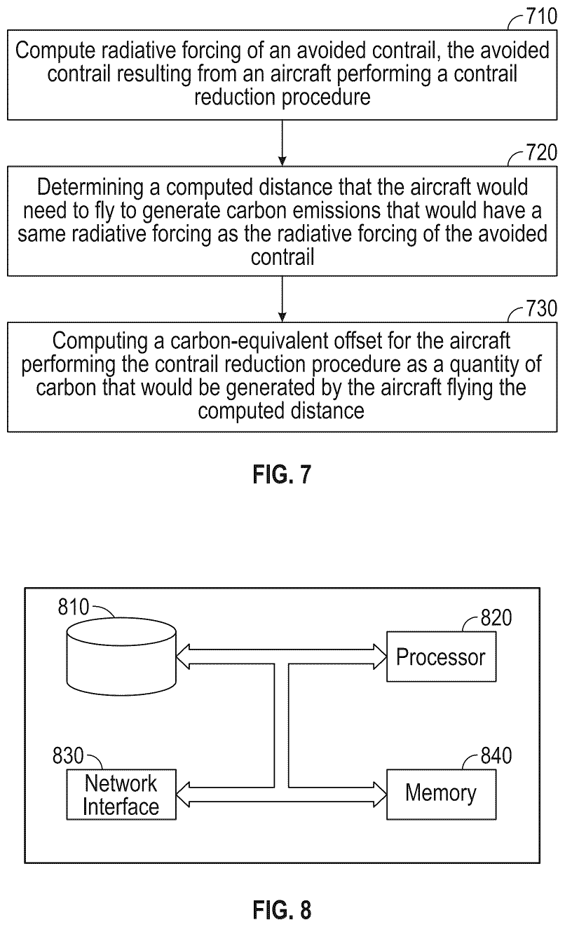

FIG. 7 is a flow diagram of example operations of a system that computes a carbon-equivalent offset for the aircraft performing the contrail reduction procedure.

At block 710, the operation involves computing radiative forcing of an avoided contrail, where the avoided contrail results from an aircraft performing a contrail reduction procedure. In various embodiments, the radiative forcing of the avoided contrail (RF_{Con}) can be computed using equation (1) above.

At block 720, the operation involves determining a computed distance that the aircraft would need to fly to generate carbon emissions that would have the same radiative forcing as the radiative forcing of the avoided contrail. In various embodiments, the computed distance (Dist) can be computed using equation (2b) above, based on the radiative forcing of the avoided contrail (RF_{Con}).

At block 730, the operation involves computing a carbon-equivalent offset for the aircraft performing the contrail reduction procedure as a quantity of carbon that would be generated by the aircraft flying the computed distance. The carbon-equivalent offset for the aircraft performing the contrail reduction procedure is the same as the quantity of carbon that would be generated by the aircraft flying the computed distance. In various embodiments, the carbon-equivalent offset for the aircraft performing the contrail reduction procedure can be computed using equation (3) above, based on the computed distance (Dist).

FIG. 7 is merely illustrative, and variations are contemplated to be within the scope of the present disclosure. In various embodiments, the operations may include other operations not shown in FIG. 7. In various embodiments, other equations or techniques may be used for computing the quantities of FIG. 7. Such and other variations are contemplated to be within the scope of the present disclosure.

FIG. 8 is a block diagram of example components of a system that provides any portion of the platform or any portion of the services described herein. The system includes an electronic storage 810, a processor 820, a memory 850, and a network interface 840. The various components may be communicatively coupled with each other. The processor 820 may be and may include any type of processor, such as a single-core central processing unit (CPU), a multi-core CPU, a microprocessor, a digital signal processor (DSP), a System-on-Chip (SoC), or any other type of processor. The memory 850 may be a volatile type of memory, e.g., RAM, or a non-volatile type of memory, e.g., NAND flash memory. The memory 850 includes processor-readable instructions that are executable by the processor 820 to cause the system to perform various operations, including those mentioned herein, such as the operations described in connection with of FIG. 1A, FIG. 1B, and/or FIG. 2.

The electronic storage 810 may be and include any type of electronic storage used for storing data, such as hard disk drive, solid state drive, and/or optical disc, among other types of electronic storage. The electronic storage 810 stores processor-readable instructions for causing the system to perform its operations and stores data associated with such operations, such as storing data relating to any of the databases 142-146 or relating to carbon-equivalent offsets from contrail reduction, among other data. The network interface 840 may implement networking technologies, such as Ethernet, Wi-Fi, and/or other wireless networking technologies.

The components shown in FIG. 8 are merely examples, and persons skilled in the art will understand that a system includes other components not illustrated and may include multiples of any of the illustrated components. Such and other embodiments are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A system comprising:
at least one processor; and
at least one memory storing instructions which, when executed by the at least one processor, cause the system at least to perform:
computing radiative forcing of an avoided contrail, the avoided contrail resulting from an aircraft performing a contrail reduction procedure;
determining a computed distance that the aircraft would need to fly to generate carbon emissions that would have a same radiative forcing as the radiative forcing of the avoided contrail; and
computing a carbon-equivalent offset for the aircraft performing the contrail reduction procedure as a quantity of carbon that would be generated by the aircraft flying the computed distance.

2. The system of claim 1, wherein the computing the radiative forcing of the avoided contrail is based on at least one of:
a length of the avoided contrail (L_{Con}),
a width of the avoided contrail (W_{Con}),
an equilibrium surface temperature response, per unit radiative forcing, relative to that of CO₂ (E), or
degree of climate impact had the avoided contrail not been avoided (M_{Contrail}), wherein M_{Contrail} is based on a time horizon (H) and one of: absolute global warming potential (AGWP), or absolute global temperature potential (AGTP).

3. The system of claim 2, wherein the computing the radiative forcing of the avoided contrail (RF_{Con}) comprises computing the RF_{Con} as:
$${RF}_{Con} = {L}_{Con} * {W}_{Con} * E * {M}_{Contrail} ( H ) .$$

4. The system of claim 1, wherein the determining the computed distance that the aircraft would need to fly to generate carbon emissions that would have the same radiative forcing as the radiative forcing of the avoided contrail is based on at least one of:
the radiative forcing of the avoided contrail (RF_{Con}),
a fuel burn per distance (FB),
an emissions index (EI), or
degree of climate impact from the carbon emissions that would have been generated by the aircraft flying the computed distance (M_{CO2}), wherein M_{CO2} is based on a time horizon (H) and one of: absolute global warming potential (AGWP), or absolute global temperature potential (AGTP).

5. The system of claim 4, wherein the fuel burn per distance is an aircraft-specific value that is specific to the aircraft.

6. The system of claim 4, the determining the computed distance (Dist) that the aircraft would need to fly to generate carbon emissions that would have the same radiative forcing as the radiative forcing of the avoided contrail comprises computing the Dist as:
$$Dist = {RF}_{Con} / ( FB * EI * {M}_{CO 2} ( H ) ) .$$

7. The system of claim 1, wherein the computing the carbon-equivalent offset for the aircraft performing the contrail reduction procedure is based on at least one of:
the computed distance (Dist) that the aircraft would need to fly to generate carbon emissions that would have the same radiative forcing as the radiative forcing of the avoided contrail,
a fuel burn per distance (FB), or
an emissions index (EI).

8. The system of claim 7, wherein the fuel burn per distance is an aircraft-specific value that is specific to the aircraft.

9. The system of claim 7, wherein the computing the carbon-equivalent offset for the aircraft performing the contrail reduction procedure comprises computing the carbon-equivalent offset as:
$$carbon - equivalent offset = Dist * FB * EI .$$

10. A method comprising:
computing radiative forcing of an avoided contrail, the avoided contrail resulting from an aircraft performing a contrail reduction procedure;
determining a computed distance that the aircraft would need to fly to generate carbon emissions that would have a same radiative forcing as the radiative forcing of the avoided contrail; and
computing a carbon-equivalent offset for the aircraft performing the contrail reduction procedure as a quantity of carbon that would be generated by the aircraft flying the computed distance.

11. The method of claim 10, wherein the computing the radiative forcing of the avoided contrail is based on at least one of:
a length of the avoided contrail (L_{Con}),
a width of the avoided contrail (W_{Con}),
an equilibrium surface temperature response, per unit radiative forcing, relative to that of CO₂ (E), or
degree of climate impact had the avoided contrail not been avoided (M_{Contrail}), wherein M_{Contrail} is based on a time horizon (H) and one of: absolute global warming potential (AGWP), or absolute global temperature potential (AGTP).

12. The method of claim 11, wherein the computing the radiative forcing of the avoided contrail (RF_{Con}) comprises computing the RF_{Con} as:
$${RF}_{Con} = {L}_{Con} * {W}_{Con} * E * {M}_{Contrail} ( H ) .$$

13. The method of claim 10, wherein the determining the computed distance that the aircraft would need to fly to generate carbon emissions that would have the same radiative forcing as the radiative forcing of the avoided contrail is based on at least one of:
the radiative forcing of the avoided contrail (RF_{Con}),
a fuel burn per distance (FB),
an emissions index (EI), or
degree of climate impact from the carbon emissions that would have been generated by the aircraft flying the computed distance (M_{CO2}), wherein M_{CO2} is based on a time horizon (H) and one of: absolute global warming potential (AGWP), or absolute global temperature potential (AGTP).

14. The method of claim 13, wherein the fuel burn per distance is an aircraft-specific value that is specific to the aircraft.

15. The method of claim 13, the determining the computed distance (Dist) that the aircraft would need to fly to generate carbon emissions that would have the same radiative forcing as the radiative forcing of the avoided contrail comprises computing the Dist as:
$$Dist = {RF}_{Con} / ( FB * EI * {M}_{CO 2} ( H ) ) .$$

16. The method of claim 10, wherein the computing the carbon-equivalent offset for the aircraft performing the contrail reduction procedure is based on at least one of:
the computed distance (Dist) that the aircraft would need to fly to generate carbon emissions that would have the same radiative forcing as the radiative forcing of the avoided contrail,
a fuel burn per distance (FB), or
an emissions index (EI).

17. The method of claim 16, wherein the fuel burn per distance is an aircraft-specific value that is specific to the aircraft.

18. The method of claim 16, wherein the computing the carbon-equivalent offset for the aircraft performing the contrail reduction procedure comprises computing the carbon-equivalent offset as:
$$carbon - equivalent offset = Dist * FB * EI .$$

19. A processor-readable medium storing instructions which, when executed by at least one processor of a system, cause the system at least to perform:
computing radiative forcing of an avoided contrail, the avoided contrail resulting from an aircraft performing a contrail reduction procedure;
determining a computed distance that the aircraft would need to fly to generate carbon emissions that would have a same radiative forcing as the radiative forcing of the avoided contrail; and
computing a carbon-equivalent offset for the aircraft performing the contrail reduction procedure as a quantity of carbon that would be generated by the aircraft flying the computed distance.

20. The processor-readable medium of claim 19, wherein the computing the carbon-equivalent offset for the aircraft performing the contrail reduction procedure is based on at least one an aircraft-specific value that is specific to the aircraft.
